(19) United States
(12) Patent Application Publication
(10) Pub. No.: US 2013/0103445 A1
(43) Pub. Date: Apr. 25, 2013

(54) METHOD AND SYSTEM FOR SMART QUESTION ROUTING

(71) Applicant: Bazaarvoice, Inc., Austin, TX (US)

(72) Inventors: Santiago Alonso Lord, New York, NY (US); Kevin J. Daniels, Leander, TX (US); Melanie T. Moy, Austin, TX (US); Brian Daniel Luskey, Austin, TX (US)

(73) Assignee: Bazaarvoice, Inc., Austin, TX (US)

(21) Appl. No.: 13/660,409

(22) Filed: Oct. 25, 2012

Related U.S. Application Data
(60) Provisional application No. 61/551,303, filed on Oct. 25, 2011.

(51) Int. Cl. G06Q 10/00

(52) U.S. Cl. 705/7.14

(57) ABSTRACT

A user generated question corresponding to a product may be received at a computer system implementing a smart question routing module. The computer system may determine the product corresponding to the user generated question and select one or more candidates from a set of subscribers to answer the user generated question based on a performance metric relating to the product. The performance metric may be determined based on criteria and/or weighting factors relating to individual ones of the subscribers. In some cases, the selection of one or more candidates may be affected by whether a subscriber is a past contributor to user generated content about the product and/or a past purchaser. The computer system may cause a request to answer the user generated question to be sent to each of the selected one or more candidates.

### CROSS-REFERENCE TO RELATED APPLICATION

This application claims a benefit of priority under 35 U.S.C. §119(e) to U.S. Provisional Application No. 61/551,303, filed Oct. 25, 2011, entitled “METHOD AND SYSTEM FOR SMART QUESTION ROUTING,” the entire disclosure of which is hereby fully incorporated herein for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This disclosure relates generally to processing user generated content. More particularly, this disclosure relates to intelligently routing user generated content to entities that may be qualified to respond to subject matter relating to the user generated content.

### BACKGROUND

Distribution and use of user generated content may be increasingly important in the modern marketplace. It is possible, in many cases, for a user to generate content with respect to a product, brand, category, manufacturer, etc. at a web site, such as a retailer's site, a manufacturer's site, or other site altogether. As the presence of this user generated content may in some cases be used to drive increased sales of products (e.g., goods or services relating to the user generated content), it is therefore desired to actively promote the generation of user generated content. This may be particularly true with respect to certain types of content that may be relatively difficult to obtain.

For a variety of reasons, users may not be highly motivated to generate or respond to a certain type of content, or may be unable to find content to which the users may otherwise be motivated to respond. In some cases, users that are motivated to respond by generating content may not be accessible by conventional techniques. For example, conventional techniques may require that users be logged onto a site in order to present the users with content for possible response.

### BRIEF DESCRIPTION OF THE DRAWINGS

The drawings accompanying and forming part of this specification are included to depict certain aspects embodiments of the present disclosure. A clearer impression of the methods and systems for smart question routing will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 depicts a diagrammatic representation of one example system including a smart question routing module.

FIG. 2 depicts a flow diagram illustrating one example of a subscription process.

FIG. 3 depicts a flow diagram illustrating one example of a question routing process.

FIG. 4 depicts a flow diagram illustrating one example of a smart question routing process.

FIG. 5 depicts a block diagram illustrating aspects of one example smart question routing module.

FIG. 6 depicts one example subscription interface.

FIG. 7 depicts one example interface of a smart question routing module.

### DETAILED DESCRIPTION

Example embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the description. It should be understood, however, that the detailed description and the specific examples, while indicating preferred embodiments of the present disclosure, are given by way of illustration only and not by way of limitation. Various substitutions, modifications, additions and/or rearrangements within the spirit and/or scope of the underlying inventive concept will become apparent to those skilled in the art from this disclosure. Embodiments discussed herein can be implemented as suitable computer-executable instructions that may reside on a computer readable medium (e.g., a hard disk (HD)), hardware circuitry or the like, or any combination.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited only those elements but may include other elements not expressly listed or inherent to such process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such non-limiting examples and illustrations includes, but is not limited to: “for example,” “for instance,” “e.g.,” “in one embodiment.”

As used herein, the term “configured to” means that a particular piece of hardware, or computer instructions, or some combination, are arranged to perform a particular task or tasks when operated. Thus, a computer system that is “configured to” perform task “A” means that the computer system includes a circuit, program instructions stored in memory, or other structure that, during operation of a computer system, performs or can be used to perform task A. As such, a computer system can be “configured to” perform task A even if the computer system is not currently on. Similarly, computer executable instructions or a computer readable medium that is “configured to” perform task B includes instructions, that if executed by a computer system, perform task B. A “module” may be hardware, instructions, or other structure, or some combination that is configured to perform a particular task.

Before discussing specific embodiments a brief overview of the context of the disclosure may be helpful.

Today's consumer is inundated with advertising. In fact, advertising is so ubiquitous that it is often ignored. What is more, many people lack the belief that companies tell the truth in advertisements. As a result, word of mouth marketing and advertising has become increasingly important with respect to the sales of certain products. Word of mouth refers to the passing of information, especially recommendations, but also general information. In the context of advertising and marketing, the use of word of mouth may mean passing information between consumers or other entities, including manufacturers, experts, retailers, etc. to convey aspects or merits of a product or service, or the experience one person has related to that product or service, or related products or services.

The emergence of the importance of word of mouth marketing and advertising has coincided with the use of the Internet for researching, shopping and purchasing of products. Thus, online marketing and advertising has also become increasingly important. The use of word of mouth marketing in an online setting may therefore be an effective method for such online advertising, as consumer recommendations allow word of mouth advertising to be disseminated either online or offline. To this point, a 2007 global Nielsen survey reported that consumer recommendations are the most credible form of advertising, as cited by 78% of the study's respondents. When businesses enable customers or other types of users to write reviews, ask or answer questions from the user community, or share experiences, they create content that may become powerful forms of marketing.

This view has been widely reinforced by many merchants (“merchants” as used herein refers to any entity involved in the production, marketing, and/or selling (e.g., a seller, retailer, wholesaler) of a product (e.g., a good or service) via, for example, online and/or brick and mortar channels), as it has it has been reported that products that are presented (e.g. through marketing or sales materials) with more user generated content may benefit from greater sales and lower frequencies of returns than similar products that are presented with less user generated content. Thus, user generated content (which may comprise information such as text, audio, video, or other information submitted by a user such as a consumer or other knowledgeable party) may be useful for driving increased sales performance. In this disclosure, the term “products” broadly covers goods and services including, for example, virtual and physical goods and services.

User generated content may include data such as user reviews, user stories, ratings, comments, descriptions of problems and issues, questions/answers, or other types of content which, for example, a user may be allowed to compose or submit through online or other methods. In some cases, obtaining desired user generated content may be difficult.

One example of content that may be difficult to obtain may be referred to as question/answer content. This type of content may in some cases be generated by two distinct users. For example, a first user may generate a question to which he wishes to obtain an answer. In response to being presented with the first user's question, one or more second users may generate answers that may be helpful to the first user. These answers may also be helpful to other users. Thus, the submitted question and the corresponding answers may be displayed to other users as a technique to drive increased sales of a product, and/or to drive increased traffic at a retailer's or manufacturer's site.

In the above example of question/answer content, the one or more second users may want to answer the first user's submitted questions, but may face certain obstacles when using conventional systems. For example, the second user may not be logged onto the particular site associated with the question/answer submissions, and thus conventional techniques may be unable to present the submitted questions to the second. In other cases, a second user may be logged onto the particular site but, as discussed in detail below, may be unable to conveniently find the submitted questions to answer while browsing the site. Consequently, there may be opportunities to collect user generated content and knowledge that remain untapped.

As one example of a scenario in which a second user that is browsing a particular site is unable to conveniently locate previously submitted questions, consider that there may be numerous open questions (e.g., questions to which answers are currently being solicited, in some cases regardless of whether answers to the questions have already been received) that have are available on the particular site. As a result, it may be difficult for the second user to locate a particular question of interest among the numerous open questions that are available on the particular site. Therefore, the second user may fail to locate open questions that the second user may be willing and particularly qualified to answer.

Embodiments of the present disclosure may promote content generation opportunities to users that may be particularly willing and/or particularly qualified to generate content relating to previously-submitted user generated content (e.g., to submit answers to previously-submitted open questions). Therefore, one aspect of promoting the content generation opportunities may in some cases include identifying users who are likely to be responsive to opportunities for submitting answers to open questions. Another aspect may in some cases include identifying specific types of users (e.g., subject matter experts) that may be particularly suited to answer particular questions.

One way to identify users that may be willing to answer a given user generated question and that may be qualified to answer the given user generated question is to utilize data relating to past content submissions of candidate users. For example, there may be a correlation between a user's history of generating content about a given product and that user's likely knowledge about the given product. Similarly, the user's submission history may also correlate to a user's willingness to answer additional user generated questions.

In order to determine users that are likely to answer user generated questions, the generation of a first type of content may be linked to the generation of a second type of content (where the types of the first content and the second content may be the same or different). In particular, in certain embodiments a user that has generated a first type of content may be presented with the opportunity to generate a second type of content. For example, if a user has written a review, asked a question, or answered a question about a certain product, the user may be presented with the ability to register or subscribe (e.g., with a site) to answer questions generated by other users. In another example, a user who has generated a review on a particular product may subsequently be presented with the opportunity to answer one or more open questions corresponding to the subject matter of the review (e.g., questions relating to the same or a similar product, questions relating to a brand associated with the particular product). Similarly, a user who has answered a question about a particular product may subsequently be presented with the opportunity to answer an additional one or more “open” questions corresponding to the particular product, a similar product, a related brand, a category, etc.

According to one embodiment, a group of subscribers to a site may register to answer user generated questions regarding certain products or categories of products. The group of subscribers may be referred to herein as “experts” regarding the certain products or categories of products. Received user generated questions relating to the certain products or categories of products may be transmitted to the expert group of subscribers as a means of presenting the questions to a qualified and receptive user population.

By polling or pushing user generated questions to a group of subscribers when the subscribers are not actively engaged or logged onto the site, opportunities to answer user generated questions may be more efficiently presented to a wider audience. Accordingly, the group of subscribers may be made aware of the opportunity to answer the user generated questions without relying on the subscribers' interaction with the site. Therefore, the user generated questions may be answered more promptly and at a higher rate, resulting in fewer questions being left open. Additionally, as the size of the group of subscribers answering questions from the site increases, the user generated questions may be more proficiently and competently answered due to the growth of the collective expertise.

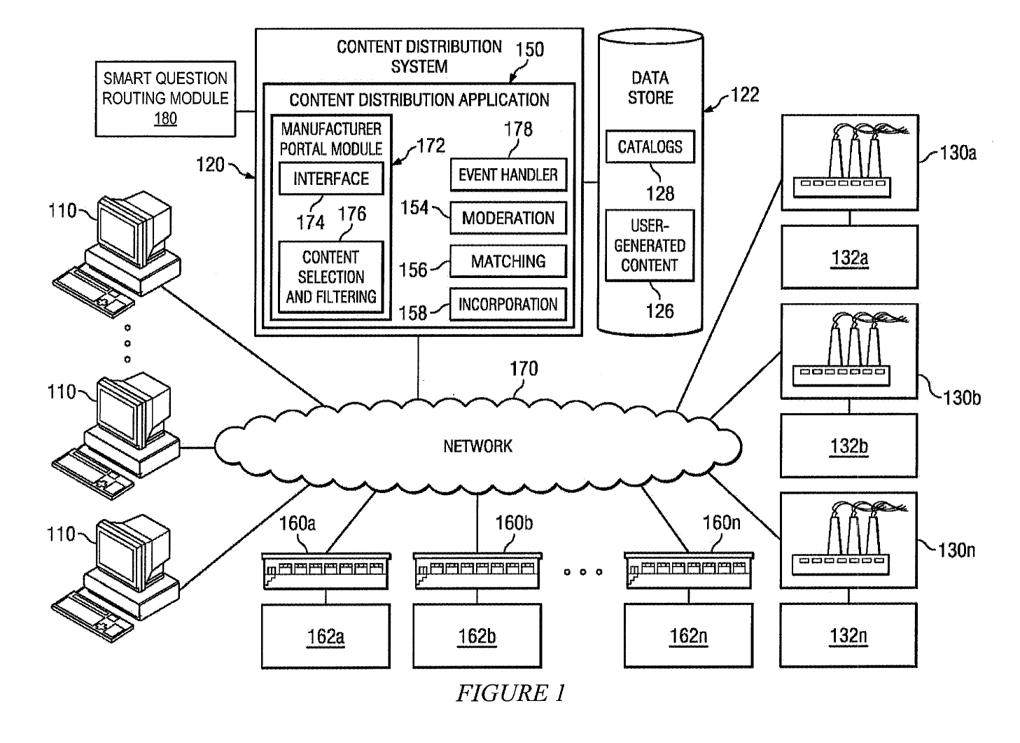

Turning now to FIG. 1, one embodiment of an architecture including one embodiment of a content distribution system is depicted. Manufacturers 130a . . . n may produce, wholesale, distribute or otherwise be affiliated with the manufacturer or distribution of one or more products. Retailers 160a . . . n may be sales outlets for products made by one or more of manufacturers 130. In many cases, each retailer 160 may sell products from multiple manufacturers 130. These products may be provided for sale at one or more websites (referred to as sites) 162a . . . n provided by each of retailers 160, such that users at computing devices 110 may access the retailer's site 162 over network 170 (for example, the Internet) in order to browse or purchase these products or perform other actions.

In addition to offering the ability to purchase these products, retailer's site 162 may offer the ability for a user to access user generated content associated with the products offered for sale on the retailer's site 162. This user generated content may include data such as user reviews, ratings, comments, descriptions of problems and issues, questions/answers, or other types of content that a user may submit. By accessing such user generated content at the retailer's site 162, the user may be better equipped to make a purchasing decision, and may be more inclined to proceed with a purchase based on, for example, positive reviews from a sufficient number of other users.

A user may thus purchase a manufacturer's product from a retailer using retailer's site 162. Retailer site 162 may furthermore offer the ability for a user to generate content with respect to products offered for sale by retailer 160, or for other products. In other words, a user may use the retailer's site 162 to generate user reviews, ratings, comments, descriptions of problems and issues, questions/answers, or other types of content regarding a product, where this user generated content may be displayed to other users (e.g., various users accessing retailer's site 162).

It will be apparent, however, that there may be many other ways to purchase or to obtain such a product. The product may be offered for sale at many physical stores (which may or may not have an online presence) and/or at other retailer's sites. Also, the product may be purchased second hand from an individual, received as a gift, etc. At some point, a person who obtained the product by means other than via retailer's site 162 may desire to provide some sort of feedback on the product, and thus may desire to submit product feedback via a means other than retailer's site 162.

To allow people to provide user generated content with respect to a particular product, manufacturers 130 may provide manufacturer's sites 132 that may provide the opportunity for a user to generate content with respect to the manufacturer's products. In other words, a user may use the manufacturer's site 132 to generate user reviews, ratings, comments, descriptions of problems and issues, questions/answers, or other types of content regarding a product, usually regardless of where the user purchased the manufacturer's product.

It should be noted that a higher volume of user generated content for a particular product may be received at the manufacturer's site 132 than at the retailer site via which the particular product is sold. This may result from the consumer having a stronger association of a product to a manufacturer than the consumer's association of the product to a retailer.

As the amount of user generated content that is available for a product at a retailer's site 162 may greatly affect sales of that product (both at that site 162 and through off-line purchases as well), it may be desirable (to both manufacturers 130 of a product and retailers 160 who sell that product) to maximize the amount of user generated content that is displayed at retailer's site 162 for a particular product. Resulting increased sales of the product may increase revenue for both retailer 160 and manufacturer 130 of the product.

Content distribution system 120 may therefore be coupled to network 170 and serve to distribute the manufacturer's collected user generated product content (content that was generated for a particular product at manufacturer's site 132) to various ones of retailers' sites 162 that offer the particular product. In some cases, the distributed content may be incorporated into each of the various retailer sites 162 where the product is offered. Thus, content distribution system 120 allows content from one manufacturer 130 (for example, the manufacturer of a product) to be presented by many retailers 160 who offer the product for sale. By centralizing the distribution and incorporation of such user generated content, a number of technical advantages may be achieved. For example, processing, moderations, and storage of such user generated content may be more efficient.

Furthermore, such a centralized distribution system may have a number of business advantages. For example, as the sale of their products is important to manufacturers 130, these manufacturers 130 may pay operators of content distribution system 120 for formatting and distributing the content to the retailer's sites 162. This is in contrast to the usual payment flows where the retailer 160 gets paid for displaying advertising, or where content aggregators get paid by portals who display the data and who in turn charge manufacturers 160 for lead generation. Similarly, since the integration of user generated content may also drive off-line purchases (e.g., in response to reading reviews of a good at a site 162, a potential purchaser may drive to a physical store to make a purchase of that good), payment may be made by a manufacturer 130 or retailer 160 irrespective of where the product was purchased (for example, on-line versus off-line purchases).

Content distribution system 120 will now be discussed in more detail. Content distributing system 120 may include one or more computers communicatively coupled to network 170 and data store 122. As is known to those skilled in the art, an exemplary computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (such as a mouse, trackball, stylist, etc.), or the like. In various embodiments, the computer has access to at least one database over the network.

ROM, RAM, and HD are computer memories for storing computer-executable instructions executable by the computer system (e.g., using the CPU). Within this disclosure, the term “computer-readable medium” is not limited to ROM, RAM, and HD and can include any type of data storage medium that can be read by a computer system. In some embodiments, a computer-readable medium may refer to a data cartridge, a data backup magnetic tape, a floppy diskette, a flash memory drive, an optical data storage drive (e.g., CD, DVD), volatile and/or non-volatile memory (e.g., ROM, RAM), HD, or other suitable storage device (or collection of storage devices).

At least portions of the functionalities or processes described herein can be implemented as suitable computer-executable instructions. The computer-executable instructions may be stored as software code components or modules on one or more computer readable media. In one embodiment, the computer-executable instructions may include instructions in one or more programming or scripting languages, such as C++, Java, JavaScript, HTML, or any other programming or scripting language.

Additionally, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

It will be noted that the term “computer system” has its ordinary and accepted meaning in the art, and includes one or more computing devices operating together and any instructions stored thereon. A computing device may include one or more processor units and a memory subsystem including a computer readable medium. A memory subsystem may store program instructions executable using the one or more processor units. The term “server” also has its ordinary and accepted meaning in the art, which includes one or more computer systems that are configured to handle requests from client computer systems—e.g., for services, data (including files, web pages, etc.), and so on.

Content distribution system 120 will now be discussed in more detail. Content distribution system 120 may include one or more computers communicatively coupled to a network 170 and a data store 122. Data store 122 may store user generated content 126 and catalogs 128. User generated content 126 may be associated with one or more products or categories, and in various cases may have been generated at manufacturer's site 132, retailer's site 162, or at another location altogether. Catalogs 128 may comprise a set of catalogs, each catalog corresponding to a retailer 160 and/or to a manufacturer 130. A catalog may comprise a set of category identifiers utilized by the retailer or manufacturer, where each category identifier may be associated with one or more product identifiers and each product identifier may be, in turn, associated with a brand name, a product name, or any number of other desired attributes. A catalog may, for example, comprise one or more Extensible Markup Language (XML) files. In some cases, these catalogs 128 may be received from retailer 160 and/or manufacturer 130, for example over network 170, at a regular or semi-regular basis. For example, catalogs may be received nightly from retailer 160 or manufacturer 130. It will be apparent that each retailer or manufacturer may provide their catalogs at different times, according to different time periods or schedules, irregularly, etc.

Catalogs 128 may also comprise one or more catalogs generated from information received from retailers 160 and/or manufacturers 130. For example, in one embodiment a global catalog associated with each manufacturer may be created by consolidating portions associated with that manufacturer of each catalog received from retailers 160 with any catalogs received from the manufacturer 130. A global catalog may, for example, comprise a set of global categories and associated global products identifiers where product identifiers and category identifiers used by the retailers for corresponding categories and products may be associated with these global identifiers.

In one embodiment, a global identifier may be associated with item information from each of a set of matched items consolidated from each of the retailer or manufacturer catalogs. As an item is added to the global catalog or an item's information is updated, the name of the category from each retailer may be added as a ‘tag’ associated with the global identifier for the item. An item can have multiple category tags. An interface may be is provided for administrators to add, combine, and rename category tags. For example, a product could be in the “LCD Monitors” category in one retailer and “19 inch Monitors” for another retailer. This item would get added under both categories in the global catalog. A user, could, if desired choose to consolidate these two categories into, for example, a “Monitors” category.

Content distribution system 120 may also include a content distribution application 150 which comprises a statistical information processing module 172, a moderation module 154, a matching module 156, an event handler module 178, and an incorporation module 158. Moderation module 154 may moderate (for example, filter or otherwise select), or allow to be moderated, content which is, or is not to be, excluded or included, while matching module 156 may serve to match received user generated content with a particular product or category. In one embodiment, this matching process may be accomplished using catalogs 128.

Incorporation module 158 may be configured to incorporate a tool for the generation of content into a manufacturer's portal, or a retailer's or manufacturer's site. Furthermore, incorporation module 158 may incorporate user generated content into a retailer's site 162, or other site, for display to a user. In particular, a user may generate content regarding a product or category at manufacturer's site 132 or retailer's site 162 using a content generation tool (for example, a GUI, webpage, widget, etc.) presented on the site. This tool may be implemented or developed by operators of content distribution system 120 and provided for use with a site to facilitate the generation of content by users, or the subsequent processing, distribution and incorporation of such content by content distribution system 120. These tools may be hosted by incorporation module 158 of content distribution system 120. Thus, for example, on a page of retailer's site 162 a content generation tool may be included, such that the tool hosted at content distribution system 120 may be incorporated in the site 162 for use by a user at the site 162.

Such content generation tools can be distributed throughout a retailer's or manufacturer's site. For example, these content generation tools may be included on a site's product pages as well as the category pages which help to organize the product page. Thus, such a content generation tool may be advantageously employed to allow content to be generated in the context of the product catalog page or category page on which it was deployed. So, for example, a module that is deployed on a television product page will receive reviews associated with that television product that may be different than the review of a wool sweater received on a module deployed on the product page for the wool sweater.

In any event, the content generated by the user with respect to a product or category may be received by content distribution system 120 and stored in association with a product or category. The received content may be moderated by moderation module 154, to determine if such content should be utilized for display on a site, or may be edited for suitability. This moderation process may comprise different levels of moderation, including auto processing the user generated content to identify blacklisted users or trusted users; human moderation which may include manually classifying content or content recategorization; proofreading; or almost any other type of moderation desired. Note, however, that such moderation may or may not be employed in certain embodiments. For example, content from certain manufacturers may not undergo such a moderation process, or may undergo moderation at a different point.

In one embodiment, this moderation process may also comprise associating tags with the received user generated content. These tags may comprise content codes which pertain to the received user generated content as will be discussed in more detail at a later point. The user generated content may also be associated with a manufacturer, products or categories of products offered for sale by retailer 160 or the manufacturer 130, a user attributes of the user who generated the content, product attributes, etc., by, in one embodiment, associating the user generated content with a product identifier for a product, or a category identifier for a category, and storing the content and the determined associations in data store 122.

At least a portion of these associations may be determined using matching module 156 which may compare data received in conjunction with the user generated content (for example, product data, category data, user data, etc.) with data in a catalog 128. Once it is decided that the user generated content is to be stored in data store 122 and allowed to be disseminated (for example, has been moderated), event handler 178 may take certain actions based on the user generated content or its associated data, such as emailing a user, sending alerts to a manufacturer that new content regarding one of their products has been received, etc. These events may be tailored to the type of content generated or other attributes of the content.

Accordingly, a user shopping at, for example, retailer's site 162 may access a web page or other portion of the site 162 corresponding to a particular product or category. User generated content 126 associated with that product or category may be displayed such that a user viewing a portion of the retailer's site associated with a particular product or category may have user generated content 126 associated with that product or category displayed to him. This user generated content, may, for example, have been generated at the retailer's site 162, through the manufacturer's site 132 or at another site. Thus, the display of this user generated content to the user while he is shopping, may, in turn, motivate the user to make a purchase through retailer's site 162.

Both the user generated content and a content generation tool may be provided in conjunction with one another on the retailer's site 162. Specifically, in one embodiment, the content from content distribution system 120 and a content generation tool may be incorporated into a portion of a web page of retailer's site 162 using an iframe or div tag (or another type of HTML element or tag, or another type of mechanism). This mechanism works in conjunction with a software module associated with content distribution system 120 (which may be implemented using JavaScript or other forms of computer readable instructions) included on the web page or at the retailer's site 162. The software module may make calls back to the incorporation module 158 on content distribution system 120 to incorporate the desired content for that page along with a content generation tool.

More particularly, in one embodiment, when a web page is loaded at retailer's site 162 the HTML, for the page may load, followed by a loading of the iframe (which may be hidden), div, table, or other mechanism which is used to incorporate content from the content provider system 120. The software module provided by the content distribution system 120 may also load at this time to access incorporation module 158 to obtain data (e.g. reviews, stories, etc., as discussed above) for inclusion in the web page in conjunction with the mechanism (div, HTML or other element) for display of the provided content.

In one embodiment, the software module associated with content provider system 120 resident on retailer's site 162 (implemented using, for example, JavaScript or other forms of computer instructions) may be executed when the web page is loaded. This program may send data such as the product data, user data, display codes, etc. to incorporation module 158. Incorporation module 158 may utilize this data to determine user generated content 126 to return and format this data accordingly. The software module on the retailer's site 162 receives content from the incorporation module 158 and copies the content into the element on the web page configured to display the content. Moreover, the ability to generate additional content may be offered, where the type of content generation opportunity offered may correspond to the type of incorporated content. For example, the opportunity to generate an additional review may be presented along with reviews that have been incorporated in the web page at the retailer's site.

It will be noted at this point that while embodiments discussed herein may be described with respect to the generation of content at one or more retailer's or manufacture's sites and the processing of such user generated content at the retailer's or manufacturer's systems, it should be understood that other embodiments may be effectively utilized to process the user generated content at other locations. As such, embodiments may be utilized where the generation of content occurs at a first location, the incorporation of content occurs at a second location and the analysis and processing of such user generated content occurs at a third location, where the first, second and third location may each be distinct from, or the same as, one or more of the other sites.

Further, as manufacturers 130 may desire to view statistical information generated with respect to their products or brands. To this end, content distribution system 120 may provide a manufacturer portal module 172 accessible by a manufacturer 130 across network 170.

As an example, manufacturer portal module 172 may comprise an interface 174 and a content selection and filtering module 176. Interface 174 may be one or more web pages or other type of interface such a graphical user interface (GUI) (which may accessed over network 170) configured to allow access by a user such as a marketing director affiliated with a manufacturer 130. By accessing this portal, a manufacturer may be presented with statistical data associated with user generated content pertinent to that manufacturer which was generated at any of retailer's sites 162 or manufacturer's sites 132.

The manufacturer may provide criteria through content selection and filtering module 176 such that the statistical data associated with the manufacturer may be filtered by the manufacturer according to a variety of criteria, such as product, brand, category, retailer, type of user generated content, statistic type, etc. The desired statistical data may be provided to the user through interface 174 of manufacturer portal module 172.

Further, the portal may also provide the ability for the manufacturer to generate content, where this manufacturer generated content (which may also be considered and referred to as user generated content) may be responsive to at least a portion of the presented user-generated content. Content generated through the manufacturer portal may be received by content distribution system 120 and stored in data store 122.

As discussed above, users may generate content, relating to one or more products provided by a manufacturer, at a retailers site 162 or at the manufacturer's site 132. This content may include questions to which a user may desire an answer. The questions may in some cases be intended for a manufacturer. The questions may be received and stored at content distribution system 120. In some embodiments disclosed herein, this type of user generated content and the like may be routed to a smart question routing module 180.

Smart question routing module 180 may be communicatively connected to content distribution system 120 over a network, or implemented as part of content distribution system 120. Smart question routing module 180 may receive a question and route the question to an individual (or group of individuals) who has subscribed to answer questions related to the product in question and/or to a product category thereof, and who has a demonstrated quality in answering such questions.

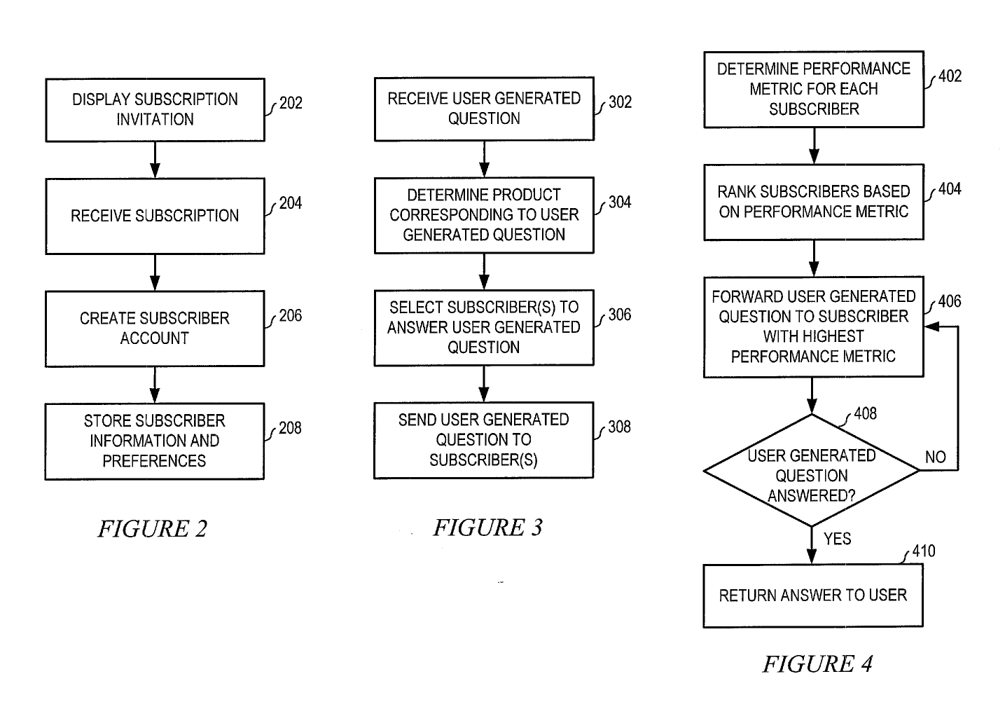

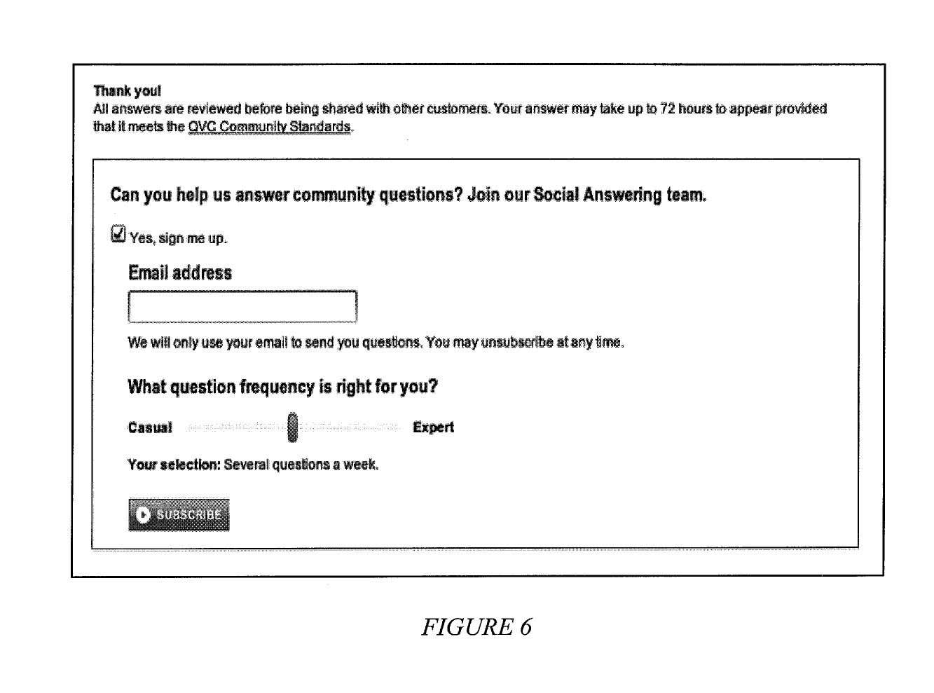

Referring to FIG. 2, such an individual may become a “subscriber” or an “expert” through interaction with a subscription interface implemented as a page or a portion thereof at a manufacturer's site 130 or a retailer's site 162. For example, a subscription invitation may be displayed to a user (step 202). The subscription invitation in some cases can be displayed to the user as a page or included as part of a Thank You page in response to the user writing a review of the product, the user answering a question related to the product, the user creating a user generated question about the product, or other user-related actions. This subscription interface can be implemented as part of smart question routing module 180 or content distribution system 120. One non-limiting example of a subscription interface implemented as a Thank You page with a subscription invitation is depicted in FIG. 6.

As illustrated in FIG. 6, the subscription interface may include a subscription invitation asking whether the user would like to become a subscriber to answer questions about a particular product or product category. These questions may come from other customers who are interested in or who have purchased the product. Furthermore, the subscription interface may include user input fields through which the user can provide an email address and/or other contact information as well as the user's correspondence frequency preferences. The frequency preferences may represent a number (or a range of numbers) of user generated questions the user is willing to answer over a given time period. The time period may be any desired length of time, such as an hour, day, week, month or year.

Thus, following the example of FIG. 6, a user may view the subscription invitation on a web page displayed via a browser application running on a user device. The user may indicate a desire to become a subscriber by selecting an appropriate “sign me up” box. The user may then provide an email address where questions are to be sent, indicate willingness to answer several questions a week. In response to the user's submission (e.g., by clicking on a “subscribe” button), the browser application may forward the user's subscription information to content distribution system 120 or smart question routing module 180 over network 170.

Referring back to FIG. 2, content distribution system 120 or smart question routing module 180 may receive the user's subscription information (step 204) and create a subscriber account accordingly (step 206). The subscriber's information and his/her preferences may then be stored (step 208), for instance, in data store 122.

In further example embodiments, the subscriber may also provide demographic information such as age and gender, geographic information such as location, etc. The subscriber may also provide membership information about social media sites and/or organizations that the subscriber belongs to. The steps of FIG. 2 may be practiced as needed to provide a user that is visiting a site supported by content distribution system 120 with a chance to become a subscriber that may answer questions related to a particular product, a product category or type, a subject relating to the product, etc. In this way, a set of site-specific (specific to a manufacturer's site 130 or a retailer's site 162) subscribers may be formed.

Other ways to reach potential subscribers and create various groups of individuals to answer questions may also be possible. For example, when a site is designated to receive support from content distribution system 120, entities associated with the site may already have a list of users registered with the site (referred to as “site users”). In one embodiment, the site users may be included as a group of “pre-seeded” subscribers that represents an initial pool of relevant users on the site that may be candidates for answering questions regarding products offered by the site. In some embodiments, these site users may have already “opted-in” to receive messages from the site. Accordingly, subscription invitations may be prepared and sent to the existing site users to invite them to answer questions as described above.

Furthermore, subscription invitations may be generated and sent via messages to people who may have direct knowledge or demonstrated expertise about a product, a category or type of the product, a subject matter related to the product, etc. As a specific example, a particular model of camera may be manufactured by manufacturer 130a. The same model of camera may be purchased by consumers through various digital/physical sales channels such as private sales, auctions, wholesalers, retailers, etc. These consumers may have direct knowledge/experience with this particular model of camera, the type of camera, the manufacturer of the camera, the various uses of the camera, etc.

Additionally, there may be users who did not purchase the particular model of camera, but who have used the same or similar model(s) of camera and have thus gained knowledge/experience about the camera. These users may form user group(s) to share their knowledge/experience with each other. A site that is communicatively connected to content distribution system 120 may support such a user group. In some cases, this site may not be directly affiliated with the manufacturer of the camera (e.g., enthusiast groups). Messages containing a subscription invitation or a link to a subscription page may be generated and sent to the user group to invite members of the group to become subscribers. When a message recipient clicks on the link and/or opens the subscription page, steps similar to those of FIG. 2 may be performed to facilitate subscription. In this way, a set of product-, product category- or subject matter-specific subscribers may be formed.

In further example embodiments, since content distribution system 120 may be communicatively connected to multiple sites (e.g., manufacturer sites 132a . . . n, retailer sites 162a . . . n), smart question routing module 180 may have access to multiple groups of subscribers associated with various entities (e.g., manufacturers 130a . . . n, retailers 160a . . . n, etc.). In some embodiments, therefore, potential candidates may be selected from groups affiliated with different sites and/or entities. In various embodiments, the potential candidates may include registered users that are consumers, enthusiasts, or other patrons of a product, brand, site, etc. In some embodiments, the potential candidates may alternately or additionally include subject matter experts that are provided by merchants or manufacturers (e.g., employee product experts that are responsible for providing answers regarding a particular product).

An exemplary computer system implementing smart question routing module 180 may be configured to receive information relating to a question that corresponds to a particular subject (e.g., a question about a product), determine the particular subject corresponding to the received information (e.g., determine the product), and select one or more candidates, from a set of individuals, to answer the question corresponding to the particular subject. The candidate selection process may be based on a performance metric relating to the particular subject. In one embodiment, the performance metric can be based on at least two criteria (e.g., responsiveness to past questions, experience relating to the product or similar products) relating to ones of the set of individuals. The computer system may cause a request to provide feedback relating to the question to be sent to each of the one or more candidates selected from the set of individuals.

As illustrated in FIG. 3, smart question routing module 180 may route a question to a subscriber who has direct knowledge or demonstrated expertise in answering the particular question. For example, the subscriber may be a past purchaser and/or contributor of user generated content relating to the good or service (or in some cases similar goods or services) corresponding to the question. Where the question may relate to a subject matter corresponding to a brand, the question may be routed to a subscriber that is considered a brand expert.

In one embodiment, the user generated question may be communicated via the site to smart question routing module 180 over network 170. As described above, the user generated question may in some cases be moderated through a moderation process to screen for questions that may include inappropriate subject matter. Subsequently, the user generated question may be placed in a queue for the site. The queue for each site may be configured to maintain a specified quantity of user generated questions, which may be site specific. Queues may be configured to purge or remove user generated questions that have already been transmitted to a subscriber to be answered, and/or that have aged past a specific length of time.

According to one embodiment, smart question routing module 180 may receive the question (step 302), determine the product corresponding to the question (step 304), determine one or more candidates from a group of subscribers based on a performance metric for each of the questions within the queue (step 306), and send the user generated questions to the subscribers (step 308). This process is described in further detail below with reference to FIG. 4.

The performance metric may be based on flexible decision logic that may be adapted over time (e.g., based on configurable weighting factors assigned to various criteria). Thus, the initial performance metric may be basic, and, upon smart question routing module 180 collecting additional data or criteria, the performance metric may be modified to optimize results by adjusting the decision logic (e.g., modifying the employed criteria, adjusting the weighting factors applied to the criteria). For example, analysis of responsiveness to recently sent questions may reveal that certain criteria are stronger indicators of timely and/or quality responses that had been originally modeled. In such cases, adjustment of the performance metric by increasing the weighting factors applied to these certain criteria may optimize performance.

In some embodiments, the smart question routing module may initially implement a single algorithm utilizing different weighting factors and criteria to determine an optimal configuration for a site. In some of these embodiments, additional algorithms may be added if needed to achieve desired performance. In some embodiments, multiple algorithms may be configured for a site, with one of the multiple algorithms being designated as an active algorithm for the site at any given time. In some embodiments, two or more algorithms may be simultaneously implemented (e.g., algorithm A for population A and algorithm B for population B) during a test period and one or more algorithms may subsequently be selected as active algorithms for extended use based on the performance of the algorithms observed during the test period.

Data for each considered subscriber may be provided to an active algorithm. A “targeting score” for each subscriber may be calculated based on the data. The subscribers may be ranked (e.g., from highest to lowest) based on their corresponding targeting score, with other factors (e.g., alphabetical) in some cases providing a secondary sort order. In one embodiment, the active algorithm may be computed nightly, producing a new index of subscribers each day. In one embodiment, a certain predetermined number of highest ranked subscribers (e.g., top three scoring subscribers) may be chosen to receive questions. In some embodiments, all subscribers having a targeting score above a predetermined threshold may be chosen to receive the questions.

In one embodiment, a plurality of categories of criteria may be utilized to determine candidates from among the subscribers. Example categories of criteria may include, but are not limited to, question relevance, historical timeliness/responsiveness, demographic information, brand activity, answer quality, an influence metric (e.g., “Klout Score”), etc.

The question relevance category of criteria may relate to, for example: I) has the subscriber answered a question for a specific product; II) has the subscriber written a review for the specific product; III) has the subscriber answered a question for a corresponding category of products; IV) has the subscriber written a review for a corresponding category of products; V) has the subscriber answered a question for the family of products; VI) has the user written a review for the family of products; VII) how many answers the candidate has provided in a certain period of time; etc. In the foregoing examples, the “product” may be a unique product created by a manufacturer, such as computer. A “category” may be a grouping of products in a certain field, such as electronics. A “family” may a subset of a category that includes related products, such as Dell Computers.

Additional criteria may relate to the demographics of the user who created the user generated question and the demographics of the subscribers that are candidates to answer the question (e.g., whether a subscriber resides within 100 miles of the asker, whether a subscriber is in the same age group as the asker, whether a subscriber is of the same gender as the asker). In some cases, the demographic information may be obtained via social media sites and/or based on registration information.

Further criteria may include demonstrated subscriber interest in the product (or product category, or product family) based on interactions with social networks. For example, a criterion may be based on how many reviews, answers, questions, or other content that a subscriber has generated across various sites for related products.

In further example embodiments, other criteria may include an influence score of the user that is based on the influence a user may have on other user, such as a Klout Score. For example, if a celebrity has subscribed to answer questions regarding products on the site, the celebrity's answers to the user generated questions may be more influential to other users on the site.

Other examples of influence-based criteria that may be employed includes a score relating to the number of TWITTER followers for a subscriber, and a score relating to the number of friends connected to the subscribers on FACEBOOK or other social networking sites.

In some embodiments, a criterion may be based on the affiliation of the subscriber as it relates to the subject matter of the question. For example, a product expert provided by a manufacturer may a more attractive candidate for some types of specification-related questions about a product. As another example, subscribers affiliated with a particular brand site may be a more attractive candidate than a subscriber affiliated with a general retail site for some types of brand-specific questions.

In further example embodiments, additional criteria may be based on whether the subscriber has previously answered an approved user generated question, and if so how quickly did the subscriber answer. For example, a criterion may quantify whether the subscriber answered an approved user generated question via smart question module 180 within ninety minutes of receiving the question.

In one exemplary case in which the product is a particular service, a criterion may in some cases be configured such that only subscribers who have previously answered at least one user generated question relating to the particular service may be considered, thus eliminating from consideration subscribers who have never answered a question about the service. In various embodiments, other such gating-type criterion may be used (e.g., users whose previous submissions fall below a predetermined quality score may be eliminated from consideration).

Criteria related to brand activity may include a measure relating to whether the subscriber has answered a first threshold number of questions on the site, and/or whether the subscriber has written a second threshold number of reviews on the site. For example, the first threshold may relate to whether the user has answered over twenty questions on the site, and the second threshold may relate to whether the subscriber has written over twenty reviews on the site.

In some cases, criteria may be bimodal, such that the values may be either a zero or a one based on whether certain conditions are present. In some cases, the values may be linear functions or other smooth functions. In some cases, the values may be discontinuous functions.

Weighting factors may be constant coefficients of corresponding criteria in some cases. In some cases, weighting factors may by smooth or discontinuous functions.

In some embodiments, criteria may include one or more answer quality factors. Such answer quality factors may be implemented as, for example, an aggregate score reflecting other users' net helpfulness votes for responses submitted by the subscribed user. For example, in some embodiments the answer quality factor may be based on an aggregate score for the number of users who found the answer helpful minus the number of users who found the answer unhelpful.

Those skilled in the art will appreciate that values for the criteria and weighting factors described above may vary from configuration to configuration and that in various embodiments the performance metric may not include all of the criteria and weighting factors described above, and/or may include other criteria or weighting factors.

As an example, one performance metric for each subscriber to a site may be represented by Equation (1), shown below.

$$Performance metric = \# questions answered for that product ( userId ) * weight\_ 1 + \# reviews written for that product ( userId ) * weight\_ 2 + \# questions answered for that category ( userId ) * weight\_ 3 + \# reviews written for products in that category ( userId ) * weight\_ 4 + \# questions answered for products in that family ( userId ) * weight\_ 5 + \# reviews written for products in that family ( userId ) * weight\_ 6 + \# S . A . approved \cdot questions answered ( userId ) * weight\_ 7 + \# S . A . questions answered in less than 90 minutes ( userId ) * weight\_ 8 + Has answered > 20 questions on the site [ 1 \vert 0 ] * weight\_ 9 + Has written > 10 reviews on the site [ 1 \vert 0 ] * weight\_ 10 + ( Helpful \text{-} Unhelpful votes ) \text{/} Questions Answered ( userId ) * weight\_ 11 + Resides within 100 miles of the asker * weight\_ 12 + Same age group as asker * weight\_ 13 + Same gender as asker * weight\_ 14 + ( Twitter followers / 100 ) * weight\_ 15 + Klout score ( if > 50 ) * weight\_ 16. \qquad Equation ( 1 )$$

In the above Equation (1), the userID may be an identifier uniquely identifying each of the subscribed users for a site, each weight may be configurable for each site, and each criterion may be based on question relevance, smart question routing, brand activity and answer quality. Each of the categories may have different criteria that are determined for each subscriber and are given configurable weighting factors for each site.

As discussed above, algorithms utilized for a site can be the same, and also may be configured with different weight values (weight configuration sets). In one embodiment, an algorithm for the site may be designated manually and a weight configuration set may be selected programmatically using a round robin configuration in which the available sets of weight configurations are rotated through for each question that smart question routing module 180 (or a decision engine thereof, see below) processes.

Referring to FIG. 4, smart question routing module 180 may determine a performance metric for each of a group of subscribers who may be able and willing to answer a user generated question (step 402) as a way to quantify each subscriber's ability to answer the user generated question. Smart question routing module 180 may rank or order the subscribers (referred to herein as candidates) based on a corresponding performance metric (step 404). If the performance metrics for multiple subscribers are equal, the subscribers with the equal performance metric may be ordered alphabetically or according to another scheme. In one embodiment, a subset of candidates is selected to answer the user generated question.

Smart question routing module 180 may cause a request to answer the user generated question to be sent to each of the selected candidates (step 406). For example, smart question routing module 180 may cause the user generated question to be forwarded to each selected candidate (e.g., via an email message). In some embodiments, each such email message may include a link to an interface through which a subscriber may answer the user generated question. If so desired, the subscriber may answer the user generated question by entering content (e.g., typing textual content into a form) and causing the content to be submitted (e.g., by clicking on a “submit” button). Upon the user submitting the content, the newly-submitted answer may be communicated to smart question routing module 180. In some embodiments, the answer submitted by the subscriber may be routed to a moderation module before the answer is displayed on the site.

In one embodiment, the amount of time from when the user generated question is communicated to a subscriber may be measured. After a predetermined time period (e.g., ninety minutes) further action may be taken based on whether the user generated question has been answered by the subscriber (step 408). For example, if the question has not been answered by the subscriber, smart question routing module 180 may transmit the user generated question to another subscriber having the next highest performance metric(s).

In a further example embodiment, the email with the link to answer the user generated question may include a “decline to answer” option. If a subscriber selects the “decline to answer” option, smart question routing module 180 may proceed to send an email with the link to answer the user generated question to the next highest ranked subscriber based on the determined performance metric for the question.

The above described process may be repeated over a time period until the user generated question is answered by a subscriber and forwarded to the asker (step 410). However, in some embodiments the user generated question may not remain in the queue for longer than a predetermined time period. For example, the user generated question may expire after thirty days and be removed from the queue.

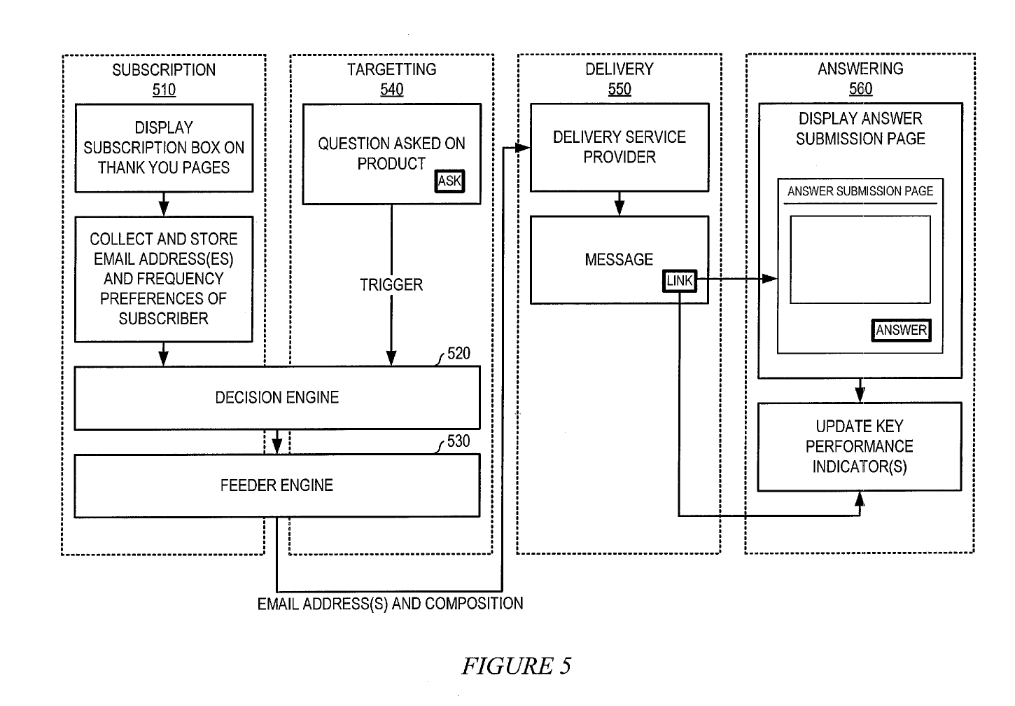

Aspects of one example smart question routing module will now be described in further detail with reference to FIG. 5.

At subscription stage 510, a client device may display a page from a site based on a user's interaction with the site. For example, the page may be a thank you page related to a product that is displayed in response to the user writing a review of a product, or in response to the user creating a user generated question about the product.

The page may include an invitation to subscribe to a group to receive user generation questions about a product or products on the site. Furthermore, the page may request that the user provide an email address or other contact information and frequency preferences of the user. If the user accepts the invitation to become a subscriber, the user's contact information and frequency preferences may be collected, stored, and made accessible by decision engine 520.

The decision engine may be configured to determine a set of subscribers to which a particular question should be sent. The algorithm employed by the decision engine may be automatically modified over time to optimize performance (e.g., building greater complexity as more performance data is collected).

In one embodiment, initially, the decision logic may implement the following:
The decision logic acts on questions that have been approved through the moderation process.
Once an approved question comes into the queue, the decision engine may search for available subscribers based on whether their time interval for receiving questions has expired.
The data for each available subscriber is passed through the decision algorithm and stack-ranked according to score.
The decision engine may select the top three subscribers and pass them on to the feeder engine (e.g., feeder engine 530).
A timer starts on that open question. Initially, it can be configured for 90 minutes. This value is configurable.
After 90 minutes, if the question has not been answered (either through smart question routing module 180 or the site itself), the decision engine may find a new set of three candidates. The decision engine may keep track of the candidates to whom the user generated question have been sent so as not to ever send the same subscriber the same question again.
Unless a question is purged, the decision engine may keep repeating the process until the question is answered. This means that there may be times that the decision engine cannot find valid subscribers. The decision engine may wait until valid ones are available.

According to one embodiment, the maximum number of questions in the queue at any point in time is 200. This number is configurable. After the maximum has been reached, one embodiment can purge questions that have been sent out once and replace them with new questions. In one embodiment, a question expires after 30 days in the engine and is purged.

At targeting stage 540, a user may generate a question on a site. The question may be related to a particular subject, such as a product, product category, products family, a particular subject, etc. In one embodiment, the question may be received at a web site of a first merchant associated with a particular subject. The decision logic may select candidates from one or more users of the web site of the first merchant to answer the question. In one embodiment, one or more users of a web site of second merchant associated with the particular subject may also (or alternately) be selected as candidate(s) to answer the question.

In one embodiment, one or more users of a web site of a manufacturer associated with the particular subject may additionally or alternately be selected as candidate(s) to answer the question. In one embodiment, the question corresponding to the particular subject may be received at a web site of an offeror of the particular subject, and the decision logic may operate to select individuals identified by a supplier (that is different from the offeror) of the particular product to answer the question. Thus, the question corresponding to a particular subject may be received at a web site of a particular entity, and candidates selected to answer the question may include users of one or more web sites corresponding to entities including or other than the particular entity.

In one embodiment, the decision logic may operate to determine whether individual members of a certain group are allowable as candidates for answering the question (e.g., based on business rules such as subscription to sites of competing merchants).

The user generated question may in some cases be submitted by an unsubscribed visitor. In other embodiments, the submission of user generated questions may be limited to registered subscribers of a site. In further example embodiments, the user generated question may be moderated through a moderation process to approve question. Approval of the user generated question for the site may trigger decision engine 520 to determine a performance metric for each of the subscribers. As described above with reference to FIG. 4, decision engine 520 may rank the subscribers based on various performance metrics and may select one or more candidates to answer the user generated question.

Based on the selection of candidate(s) by decision engine 520, feeder engine 530 for smart question routing module 180 may automatically or autonomously push the user generated question to the selected candidate(s). In this way, a subscriber may receive user generated questions without having to browse the site or otherwise be active on the site.

For example, feeder engine 530 may prepare and send an email message to each selected subscriber via an email service provider. At delivery stage 530, the email service provider may forward the email message to an email address provided by the selected subscriber. The email message may include a link that is usable to access the user generated question.

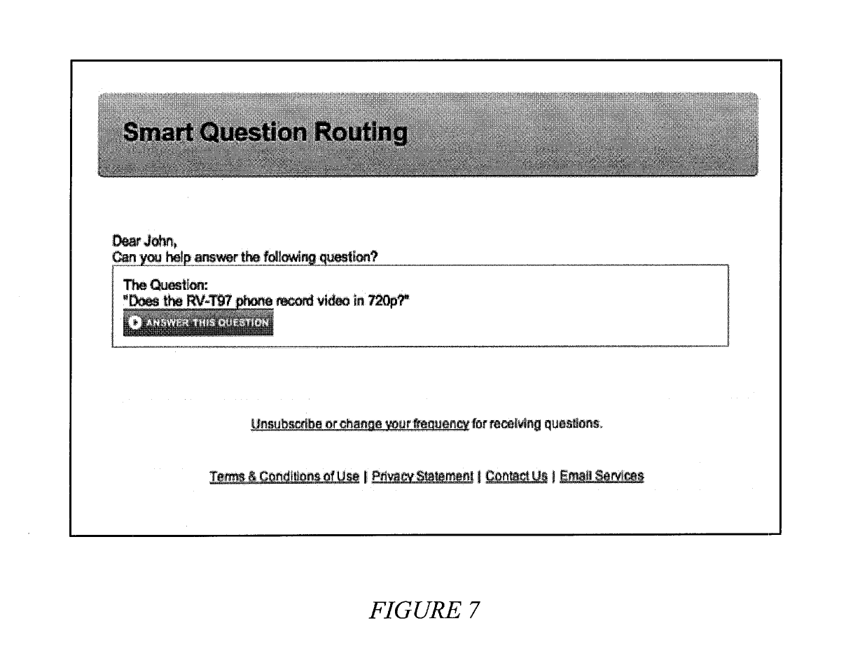

At answering stage 560, the subscriber may receive a message relating to the user generated question. As described above, the message may be pushed to the subscriber as part of an email message. Other types of messages may also be possible. For example, the message may be pushed to the subscriber as an instant message, a web page, text message, etc. One example of a message providing a user generated question to a selected subscriber, along with a link to an answer submission interface is depicted in FIG. 7.

If the subscriber chooses to answer the user generated question, he or she may select or click on the link in the message which, in turn, may direct the subscriber (e.g., via a browser running on the subscriber's computer) to an answer submission page. The subscriber may use the answer submission page to answer the user generated question, for example by typing an answer in an input box provided on the answer submission page. The answer submission page may include a “submit” or “answer” button which, when selected, may cause the answer provided in the input box to be transmitted to smart question routing module 180. In further example embodiments, the answer submission page or interface may be provided within the body of the email.

In one embodiment, the answer(s) to the user generated question may be incorporated into the site. For example, the answer(s) may be stored in data store 122 and utilized by incorporation module 158 to determine which content to provide in response to a subsequent request for content on the site. Such answer(s) may be displayed in a similar context as the user generated question (for example, on the same pages or in the same location, etc.) and may be displayed in association with the original content. In this way, it may be apparent that answers are responsive to the user generated question.

In one embodiment, smart question module 180 may keep track of Key Performance Indicators (KPI) and update the weighting factors discussed above to determine metrics that are predictive of future performance. For example, the KPI may decrease a score for a subscriber if the subscriber declines to answer a user generated question specifically sent to him or her. Further, the KPI may further update a score for the subscriber, as discussed above, based on the helpfulness of the answer provided by the subscriber.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment,” “an embodiment,” “a specific embodiment,” “some embodiments,” “various embodiments” or similar terminology means that a particular feature, structure, or characteristic described in connection with the embodiment is included in at least one embodiment and may not necessarily be present in all embodiments. Thus, respective appearances these phrases in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

What is claimed is:

1. A method, comprising:
receiving, at a computer system, a user generated question corresponding to a particular product;
determining, using the computer system, the particular product corresponding to the user generated question;
selecting one or more candidates from a set of subscribers to answer the user generated question, wherein the selecting the one or more candidates is performed using the computer system and is based on a performance metric relating to the particular product, and wherein the performance metric is based on at least two criteria relating to individual subscribers in the set of subscribers and on at least two weighting factors; and
causing, using the computer system, a request to answer the user generated question to be sent to each of the selected one or more candidates.

2. The method of claim 1,
wherein the particular product is a service; and
wherein the at least two criteria include at least one criteria relating to an individual subscriber's prior contributions of user generated content relating to the service.

3. The method of claim 1,
wherein the selecting the one or more candidates from the set of subscribers to answer the user generated question comprises eliminating any subscriber in the set of subscribers who has not previously answered any question about the particular product.

4. The method of claim 3,
wherein the at least two weighting factors includes a bimodal weighting factor that is configured to facilitate the eliminating.

5. The method of claim 1,
wherein the selecting the one or more candidates from the set of subscribers to answer the user generated question comprises selecting only previous purchasers of the particular product.

6. The method of claim 1, wherein the at least two criteria include:
a quantity score representing a number of prior content submissions by a subscriber; and
a quality score representing helpfulness of the prior content submissions by the subscriber.

7. The method of claim 6, wherein the quality score is based on helpfulness ratings relating to the prior content submissions associated with the particular product.

8. The method of claim 6, wherein the quality score is based on helpfulness ratings relating to prior content submissions associated with a product category of the particular product.

9. The method of claim 1, wherein the at least two weighting factors include:
a first weighting factor configured to exclude any subscriber in the set of subscribers corresponding to a quality of prior content submissions falling below a first threshold; and
a second weighting factor configured to scale the performance metric inversely with respect to time required to submit prior contributions of answers.

10. The method of claim 1, further comprising:
adjusting the performance metric based on at least one performance indicator, wherein the at least one performance indicator relates to responses received from the one or more candidates in response to requests to answer the user generated question.

11. A system, comprising:
one or more processors;
a memory, coupled to the one or more processors, having stored thereon instructions executable by the system to cause the system to:
receive information relating to a question that corresponds to a particular subject;
determine the particular subject corresponding to the received information;
select one or more candidates, from a set of individuals, to answer the question corresponding to the particular subject, wherein the selecting the one or more candidates is based on a performance metric relating to the particular subject, and wherein the performance metric is based on at least two criteria relating to ones of the set of individuals; and
cause a request to provide feedback relating to the question to be sent to each of the one or more candidates selected from the set of individuals.

12. The system of claim 11,
wherein the particular subject is a good or service; and
wherein the set of individuals comprises previous contributors of user generated content relating to the good or service.

13. The system of claim 11,
wherein the particular subject is a brand; and
wherein the set of individuals comprises users identified as brand experts.

14. The system of claim 11,
wherein the question corresponding to the particular subject is received at a web site of a first merchant that offers the particular subject; and
wherein the one or more candidates comprise:
one or more users of the web site of the first merchant; and
one or more users of a web site of second merchant that offers the particular subject.

15. The system of claim 11, wherein the one or more candidates further comprise:
one or more users of a web site of a manufacturer of the particular subject.

16. The system of claim 11,
wherein the question corresponding to the particular subject is received at a web site of a merchant that offers the particular subject; and
wherein the one or more candidates comprises individuals identified by a supplier of the particular product, wherein the supplier is different from the merchant.

17. The system of claim 11,
wherein the question corresponding to the particular subject is received at a web site of a particular entity;
wherein the set of individuals includes users of one or more web sites corresponding to entities other than the particular entity; and
wherein the selecting the one or more candidates includes determining whether individual members of the set of individuals are allowable as candidates for answering the question corresponding to the particular subject received at the web site of the particular entity.

18. The system of claim 11,
wherein the performance metric is further based on at least two weighting factors; and
wherein the instructions are further executable by the one or more processors to cause the system to adjust the performance metric by changing one or more of the at least two weighting factors.

19. An article of manufacture comprising a non-transitory computer-readable medium having stored thereon instructions that, responsive to execution by a computing device, cause the computing device to perform operations comprising:
receiving information relating to a question that corresponds to a particular subject;
determining the particular subject corresponding to the received information;
selecting one or more candidates, from a set of individuals, to answer the question, wherein the selecting is based on a performance metric relating to the particular subject, and wherein the performance metric is based on at least two criteria relating to ones of the set of individuals; and
causing a request to provide feedback relating to the question to be sent to each of the selected one or more candidates.

20. The article of manufacture of claim 19,
wherein the particular subject is a good or service; and
wherein the set of individuals comprises previous contributors of user generated content relating to the good or service, past purchasers of the good or service, or a combination thereof.
